(19) United States
(12) Patent Application Publication
(10) Pub. No.: US 2025/0306173 A1
(43) Pub. Date: Oct. 2, 2025

(54) LIGHT DETECTION AND DATA ACQUISITION AND PROCESSING DEVICE, LIDAR AND DETECTION METHOD THEREOF

(71) Applicant: HESAI TECHNOLOGY CO., LTD., Shanghai (CN)

(72) Inventors: Jun TAO, Shanghai (CN); Shiwei ZHENG, Shanghai (CN); Shaoqing XIANG, Shanghai (CN)

(21) Appl. No.: 19/235,790

(22) Filed: Jun. 12, 2025

Related U.S. Application Data
(63) Continuation of application No. PCT/CN2023/115385, filed on Aug. 29, 2023.

(30) Foreign Application Priority Data
Dec. 12, 2022 (CN) 202211598594.1

(51) Int. Cl. G01S 7/48; G01S 7/481; G01S 7/4863; G01S 7/4865; G01S 17/10

(52) U.S. Cl. CPC G01S 7/4802; G01S 7/4811; G01S 7/4816; G01S 7/4817; G01S 7/4863; G01S 7/4865; G01S 17/10

(57) ABSTRACT

The disclosure provides a LiDAR, which includes a transmitting device configured to transmit a detection light beam for detecting an object, a detection device including a plurality of detection units, each detection unit including an array of pixels, a control device coupled to the transmitting device and the detection device and configured to control the transmitting device to transmit the detection light beam, and correspondingly control one of the detection units to perform detection, and a data processing device coupled to the detection device and configured to, for at least one of the pixels, determine an echo electrical signal based on an electrical signal generated from the pixel and electrical signals generated from other pixels in the same detection unit by the transmitting device consecutively transmitting the detection light beams a plurality of times, and determine information about the object based on the echo electrical signal.

### CROSS-REFERENCE TO RELATED APPLICATIONS

This application is a continuation application of PCT Application No. PCT/CN2023/115385, filed on Aug. 29, 2023, which claims priority to Chinese Patent Application No. 202211598594.1, filed on Dec. 12, 2022, and each application is hereby incorporated by reference in its entirety. The disclosures of the aforementioned applications are hereby incorporated by reference in their entireties

### TECHNICAL FIELD

The present disclosure relates to the field of LiDAR, and in particular, to a LiDAR, a detection method for a LiDAR and an integrated light detection and data processing device.

### BACKGROUND

LiDAR is a commonly used ranging sensor and has been widely used in areas such as intelligent robots, unmanned aerial vehicles, unmanned driving and the like owing to the advantages of long detection range, high resolution, strong resistance to active interference, small size, and light weight.

FIG. 1a shows a schematic diagram of a transmitting device TX and a receiving device RX of the existing LiDAR based on discrete photosensitive units. The transmitting device TX includes N transmitting units, and the receiving device RX includes N detection units. The detection unit can be, for example, an avalanche photodiode (APD), silicon photomultiplier (SiPM), etc. The N transmitting units and N detection units form N detection channels (that is, N lines). Most existing LiDARs use the way of point scanning to detect objects. A transmitting unit transmits a detection light beam. After the detection light beam is reflected by an external object, it is detected by a corresponding detection unit. After processing by a subsequent circuit, a data point in the point cloud is generated. The N transmitting units and N detecting units are driven by a scanning device (such as a mechanical rotating type LiDAR). Alternatively, the transmitted light beams from the N transmitting units are deflected by the scanning devices to perform detection within a certain vertical and horizontal field of view. For a large object, it is typically easy for the LiDAR to perform detection, but for the detection of a small object, the requirements for the LiDAR are more stringent.

FIG. 1b shows the corresponding field-of-view angles of an object with a height of 20 cm (for example, the installation height of the LiDAR is 1.5 m) at different distances from the LiDAR. As shown in FIG. 1b, the corresponding field-of-view angle of the object with the height of 20 cm at a distance of 200 m is only 0.057°. Therefore, in order to detect this small object, it is necessary to improve the optical angular resolution of the LiDAR to 0.05°, and at the same time ensure that the distance measurement capability of the LiDAR cannot be less than 200 m. The optical angular resolution refers to the corresponding field-of-view angle of a point in the point cloud of LiDAR.

In addition, for the detection of small-sized objects at a long distance, a sufficiently high signal-to-noise ratio is required. Existing rotating LiDAR, such as a mechanical rotating LiDAR or a rotating-mirror LiDAR, improves the signal-to-noise ratio by multiple light transmission and detection in a short period of time and by superimposing the received echoes. Each time the superimposing is done, the signal can be expanded by 2 times, and the noise is expanded by \sqrt{2}. The more detection times, the higher the signal-to-noise ratio of the superimposed echo signal. However, as shown in FIG. 1c, since multiple pulses are emitted to the same position in a short period of time (for example, ΔT between T0 and T1 is 5 μs), it is prone to issues about human eye safety.

Therefore, detection of small objects at long distance and at the same time ensuring human eye safety become urgent technical issues for LiDAR that need to be solved.

The contents of the background art section are only technologies known to the discloser and do not necessarily represent the prior art in the field.

### SUMMARY

In view of one or more of the disadvantages in the existing technology, the present disclosure provides a LiDAR, which can detect small objects at long distance while taking into account human eye safety.

The LiDAR includes:
a transmitting device configured to transmit a detection light beam for detecting an object;
a detection device including a plurality of detection units, each detection unit including an array of pixels, wherein each pixel can respond to an echo of the detection light beam reflected by the object and convert the echo into an electrical signal;
a control device coupled to the transmitting device and the detection device and configured to control the transmitting device to transmit the detection light beam, and correspondingly control one of the detection units to perform detection; and
a data processing device coupled to the detection device and configured to, for at least one of the pixels, determine an echo electrical signal based on an electrical signal generated from the pixel and electrical signals generated from other pixels in the same detection unit by the transmitting device consecutively transmitting the detection light beams a plurality of times, and determine information about the object based on the echo electrical signal.

According to an aspect of the present disclosure, the data processing device is configured to: determine the echo electrical signal at a current detection angle of the LiDAR based on the electrical signal generated from the pixel at the current detection angle and the electrical signals generated from other pixels in the same detection unit by the transmitting device transmitting the detection light beams previously a plurality of times.

According to an aspect of the present disclosure, each pixel includes a plurality of single-photon avalanche diodes, each single-photon avalanche diode being independently gated and addressable.

According to an aspect of the present disclosure, the data processing device is configured to: superimpose an output signal array of the array of pixels of the same detection unit at the current detection angle and a plurality of output signal arrays of the array of pixels of the same detection unit at a plurality of prior detection angles based on a preset offset to obtain a superimposed signal array.

According to an aspect of the present disclosure, the offset for two output signal arrays generated by the array of pixels of the same detection unit through two consecutively-transmitted detection light beams is 1 pixel.

According to an aspect of the present disclosure, the offset corresponds to an angular resolution of the LiDAR.

According to an aspect of the present disclosure, the data processing device is configured to generate the echo electrical signal at the current detection angle based on the superposed signal array, and determine a distance from the object and/or a reflectivity of the object based on the echo electrical signal at the current detection angle.

According to an aspect of the present disclosure, the LiDAR further includes a rotating mirror having a plurality of reflective surfaces, wherein the detection light beam is reflected to outside of the LiDAR via one of the reflective surfaces, the echo is reflected to the detection device via the same reflective surface or a different reflective surface, and the rotating mirror is configured to be rotatable around a first axis to form a horizontal field of view of the LiDAR.

According to an aspect of the present disclosure, the LiDAR further includes a rotor on which the transmitting device and the detection device are arranged, the rotor being rotatable around a first axis to form a horizontal field of view of the LiDAR.

According to an aspect of the present disclosure, the plurality of detection units are arranged along a vertical direction to form a vertical field of view of the LiDAR.

The present disclosure also provides a detection method for a LiDAR, wherein the LiDAR includes a transmitting device and a detection device, the detection device includes a plurality of detection units, each detection unit includes an array of pixels, and the detection method includes:
S101: controlling the transmitting device to transmit a detection light beam at a current detection angle;
S102: controlling correspondingly one of the detection units to perform detection to obtain a signal array output by the array of pixels of the detection unit;
S103: for at least one of the pixels, determining an echo electrical signal based on an electrical signal generated from the pixel and electrical signals generated from other pixels in the same detection unit by the transmitting device consecutively transmitting the detection light beams a plurality of times; and
S104: determining information about the object based on the echo electrical signal.

According to an aspect of the present disclosure, the consecutively transmitting the detection light beams a plurality of times is performed before the current detection angle.

According to an aspect of the present disclosure, each pixel includes a plurality of single-photon avalanche diodes, each single-photon avalanche diode being independently gated and addressable.

According to an aspect of the present disclosure, the step S103 includes: superimposing an output signal array of the array of pixels of the same detection unit at the current detection angle and a plurality of output signal arrays of the array of pixels of the same detection unit at a plurality of prior detection angles based on a preset offset to obtain a superimposed signal array.

According to an aspect of the present disclosure, the offset for two output signal arrays generated by the array of pixels of the same detection unit through two consecutively-transmitted detection light beams is 1 pixel.

According to an aspect of the present disclosure, the offset corresponds to an angular resolution of the LiDAR.

According to an aspect of the present disclosure, the step S104 includes: generating the echo electrical signal at the current detection angle based on the superposed signal array, and determine a distance from the object and/or a reflectivity of the object based on the echo electrical signal at the current detection angle.

The present disclosure also provides an integrated light detection and data processing device, including:
a plurality of detection units, each detection unit including an array of pixels, wherein each pixel can respond to an optical signal and converts the optical signal into an electrical signal; and
a control device coupled to the plurality of detection units and configured to control the detection units to perform detection; and
a data processing device coupled to the plurality of detection units and configured to, for at least one of the pixels, determine an echo electrical signal based on the electrical signal generated from the pixel and electrical signals generated from other pixels in the same detection unit during a plurality of consecutive detections.

By adopting the technical solutions of the embodiments of the present disclosure, a superimposed signal array can be obtained by performing multiple measurements through the detection unit and superimposing the output signals of pixels corresponding to the same field-of-view area, which can effectively improve the signal-to-noise ratio of the echo, extend the maximum detection range of the LiDAR for distant detection, and improve the detection ability for small-sized objects at long distance. In addition, by expanding the time interval of multiple detections, the laser power emitted by the transmitting unit in a short period of time remains unchanged. Even if multiple measurements are performed, the risk of human eye safety will not be increased, complying with the human eye safety standard. In addition, by angularly aligning the output signal arrays of the detection unit before superimposing the output signal arrays, the output signal superimposed each time during multiple detections corresponds to the same field of view, and no offset of the field of view occurs with the scanning of the rotating mirror or the rotation of the rotor, which is beneficial to improving the accuracy of detection results. In summary, compared with existing solutions, the technical solution of the present disclosure can detect small objects at long distance while taking into account human eye safety.

### BRIEF DESCRIPTION OF THE DRAWINGS

The drawings that form a part of the present disclosure are used to provide a further understanding of the present disclosure. The illustrative embodiments of the present disclosure and their descriptions are used to explain the present disclosure and do not form an improper limitation of the present disclosure. In the drawings:

FIG. 1a shows a schematic diagram illustrating the structure of multiple transmitting units and multiple receiving units of the existing LiDAR based on discrete photosensitive units.

FIG. 1b shows a schematic diagram illustrating the corresponding field-of-view angle of an object with a height of 20 cm at different distances from the LiDAR.

FIG. 1c shows a schematic diagram illustrating the time interval for multiple detections of the detection unit in the prior art.

FIG. 2 shows a schematic diagram of an example LiDAR consistent with some embodiments of the present disclosure.

FIGS. 3a and 3b respectively show a schematic diagram of a transmitting device consistent with some embodiments of the present disclosure.

FIGS. 4a and 4b respectively show a schematic diagram of a detection device consistent with some embodiments of the present disclosure.

FIG. 4c shows an enlarged view of a detection unit consistent with some embodiments of the present disclosure;

FIG. 5 shows a schematic diagram illustrating multiple detections of the detection unit of a LiDAR in an enhanced mode consistent with some embodiments of the present disclosure;

FIG. 6 shows a schematic diagram illustrating the time interval for multiple detections of the detection unit consistent with some embodiments of the present disclosure;

FIG. 7 shows a schematic diagram illustrating multiple detections of the detection unit of a LiDAR in a default mode consistent with some embodiments of the present disclosure;

FIG. 8 shows a schematic diagram of an example LiDAR consistent with some embodiments of the present disclosure;

FIG. 9 shows a schematic diagram of a detection chip consistent with some embodiments of the present disclosure;

FIG. 10 shows a schematic diagram of an integrated light detection and data processing device consistent with some embodiments of the present disclosure;

FIG. 11 shows a schematic diagram of an integrated light detection and data processing device consistent with some embodiments of the present disclosure; and

FIG. 12 shows a flow chart of a detection method for an example LiDAR consistent with some embodiments of the present disclosure.

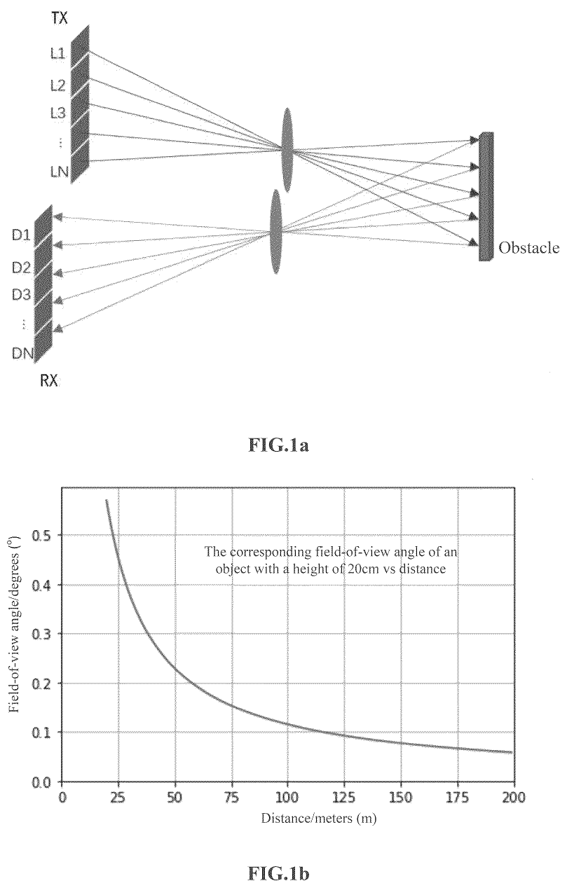

### DETAILED DESCRIPTION

In the following, only some exemplary embodiments are briefly described. The described embodiments can be modified in various different ways without departing from the spirit or scope of the present disclosure, as would be apparent to those skilled in the art. Accordingly, the drawings and descriptions are to be regarded as illustrative and not restrictive in nature.

In the description of the present disclosure, it needs to be understood that the orientation or position relations denoted by such terms as “central” “longitudinal” “latitudinal” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the accompanying drawings, and are used only for the purpose of facilitating description of the present disclosure and simplification of the description, instead of indicating or suggesting that the denoted devices or elements must be oriented specifically, or configured or operated in a specific orientation. Thus, such terms should not be construed to limit the present disclosure. In addition, such terms as “first” and “second” are only used for the purpose of description, rather than indicating or suggesting relative importance or implicitly indicating the number of the denoted technical features. Accordingly, features defined with “first” and “second” can, expressly or implicitly, include one or more of the features. In the description of the present disclosure, “plurality” means two or more, unless otherwise defined explicitly and specifically.

In the description of the present disclosure, it needs to be noted that, unless otherwise specified and defined explicitly, such terms as “installation” “coupling” and “connection” should be broadly understood as, for example, fixed connection, detachable connection, or integral connection; or mechanical connection, electrical connection or intercommunication; or direct connection, or indirect connection via an intermediary medium; or internal communication between two elements or interaction between two elements. For those skilled in the art, the specific meanings of such terms herein can be construed in light of the specific circumstances.

Herein, unless otherwise specified and defined explicitly, if a first feature is “on” or “beneath” a second feature, this can cover direct contact between the first and second features, or contact via another feature therebetween, other than the direct contact. Furthermore, if a first feature is “on”, “above”, or “over” a second feature, this can cover the case that the first feature is right above or obliquely above the second feature, or just indicate that the level of the first feature is higher than that of the second feature. If a first feature is “beneath”, “below”, or “under” a second feature, this can cover the case that the first feature is right below or obliquely below the second feature, or just indicate that the level of the first feature is lower than that of the second feature.

The disclosure below provides many different embodiments or examples so as to realize different structures described herein. In order to simplify the disclosure herein, the following will give the description of the parts and arrangements embodied in specific examples. Of course, they are only for the exemplary purpose, not intended to limit the present disclosure. Besides, the present disclosure can repeat a reference number and/or reference letter in different examples, and such repeat is for the purpose of simplification and clarity, which does not represent any relation among various embodiments and/or arrangements as discussed. In addition, the present disclosure provides examples of various specific processes and materials, but those skilled in the art can also be aware of application of other processes and/or use of other materials.

The embodiments of the present disclosure will be described below with reference to the drawings. It should be appreciated that the embodiments described here are only for the purpose of illustrating and explaining, instead of limiting, the present disclosure.

In order to improve the signal-to-noise ratio of the LiDAR, and in view of the problem of human eye safety caused by transmitting multiple pulses to the same position in a short period of time, the present disclosure provides a LiDAR operating as follows: for a pixel of the detection unit, the echo electrical signal is determined based on the electrical signal generated from the pixel and the electrical signal generated from other pixels in the same detection unit by adjacent emissions of the detection light beam from the LiDAR, and an information about objects is determined based on the echo electrical signal. Detection through this operation method of multiple and repeated measurements can effectively improve the signal-to-noise ratio of LiDAR, which is conducive to improving LiDAR's detection ability of small objects at long-distance while taking into account human eye safety, which will be described in detail below.

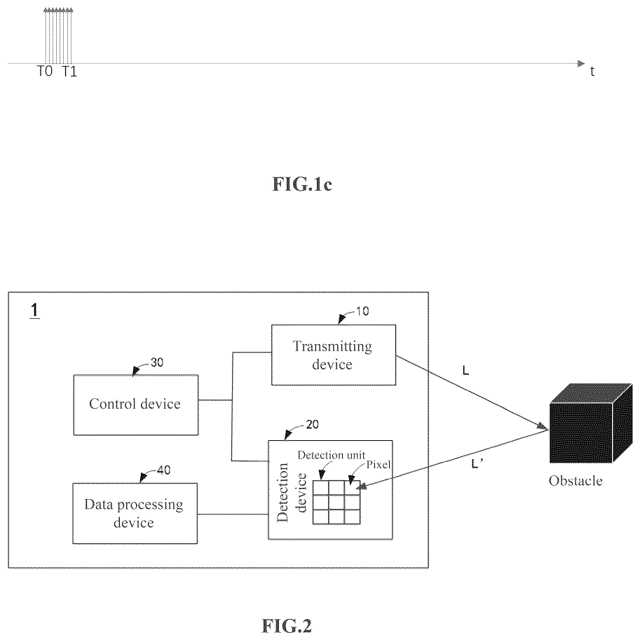

FIG. 2 shows a schematic diagram of the LiDAR 1 consistent with some embodiments of the present disclosure. As shown in FIG. 2, the LiDAR 1 includes a transmitting device 10, a detection device 20, a control device 30 and a data processing device 40. The transmitting device 10 is configured to transmit a detection light beam L for detecting objects (e.g., a cube as shown in FIG. 2). The detection device 20 includes a plurality of detection units (e.g., a detection unit is shown in FIG. 2), and each detection unit includes an array of pixels (e.g., a 3×3 array of pixels as shown in FIG. 2), where each pixel can respond to the echo L′ of the detection light beam L reflected by the object and converts it into an electrical signal. The control device 30 is coupled to the transmitting device 10 and the detection device 20, and is configured to control the transmitting device 10 to transmit the detection light beam L, and to correspondingly control one of the detection units to perform detection. The data processing device 40 is coupled to the detection device 20. For at least one of the pixels, the data processing device 40 is configured to determine an echo electrical signal based on the electrical signal generated from the pixel and the electrical signal generated from other pixels in the same detection unit by the transmitting device 10 consecutively transmitting detection light beam L multiple times, and determine the information about the object based on the echo electrical signal. In the present disclosure, the transmitting device 10 transmits the detection light beam L multiple times, which means transmitting the detection light beam L at multiple different angular positions of the LiDAR, for example, at multiple angular positions based on the angular resolution of the LiDAR as a unit. For example, the angular resolution of the LiDAR is 0.05°, the LiDAR transmits detection light beams multiple times at different horizontal angles such as 0°, 0.05°, 0.1°, 0.15°, and 0.2°.

In existing LiDARs, the transmitting device transmits a detection light beam at a certain horizontal angular position, and one of the detection units receives the corresponding echo, and determines the information about the object corresponding to the horizontal angular position based on the echo, such as distance information and/or reflectivity information of objects. The LiDAR then reaches the next horizontal angular position, repeats the above-mentioned transmission-reception detection process, and continues to generate object information corresponding to the next horizontal angular position. Therefore, during determination of object information at each horizontal angular position, it is only necessary to refer to the echo obtained at that horizontal angular position. The present disclosure is different from that. In the process of determining object information, it refers to not only the echo obtained at the current position, but also the electrical signals generated from other pixels in the same detection unit by adjacent emissions of the detection light beam, to determine the echo electrical signal, and determines information about the object based on the echo electrical signal. For example, in the process of transmitting detection light beams multiple times, the electrical signals of multiple different pixels corresponding to the same field-of-view area in the same detection unit are accumulated to calculate the detection results of the field-of-view area. Since the echo signal is obtained by the same detection unit in this detection and multiple prior adjacent detections, the signal strength is significantly increased and the signal-to-noise ratio is effectively improved, which is beneficial to improving LiDAR's detection capabilities of small objects at long distance, as compared to the single detection in the prior art.

In the embodiment as shown in FIG. 2, the control device 30 and the data processing device 40 are shown as two separate components. Those skilled in the art will understand that the two can also be integrated and implemented by one component, such as a control chip, which all fall within the protection scope of the present disclosure.

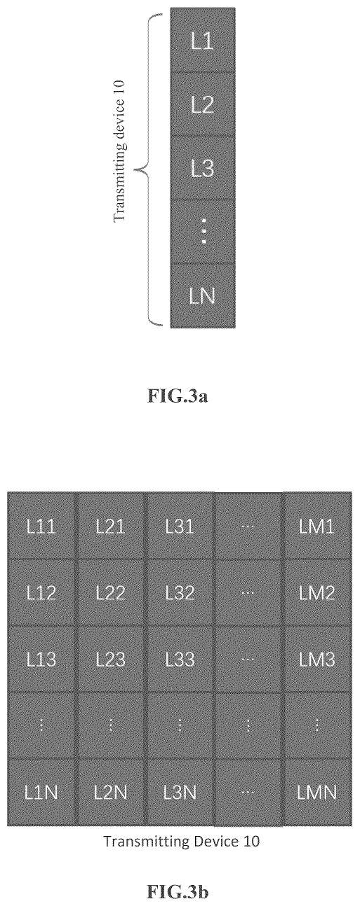

FIG. 3a shows a schematic diagram of a transmitting device 10 in some embodiments of the present disclosure. As shown in FIG. 3a, the transmitting device 10 includes a plurality of transmitting units, such as N transmitting units L1, L2, L3, . . . , LN as exemplarily shown in FIG. 3a, where N is an integer greater than or equal to 1. The plurality of transmitting units form a linear array of transmitting units.

It should be noted that the transmitting device 10 is not limited to only including a single column of transmitting units. According to another embodiment of the present disclosure, the transmitting device 10 can also include multiple columns of transmitting units, and the multiple columns of transmitting units are coupled in parallel to form a two-dimensional array of transmitting units, such as the N×M array of transmitting units exemplarily shown in FIG. 3b, where N and M are both integers greater than 1, and they can be equal or unequal, depending on the different circumstances.

The type of the transmitting unit is not limited in the present disclosure. In some embodiments, the transmitting unit can be a vertical cavity surface emitting laser (VCSEL) or an edge emitting laser (EEL), among others, which can be selected based on different needs. During the detection process of the LiDAR, each column of transmitting units can be polled to emit light every certain horizontal angle (such as 0.2°, 0.05° or 0.025°, etc.) when driven by a scanning device (such as a rotating mirror) or a rotor, thereby achieving detection of the LiDAR within a certain horizontal field of view.

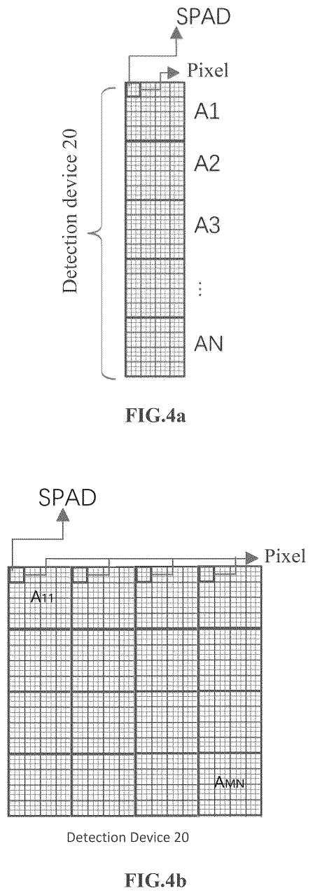

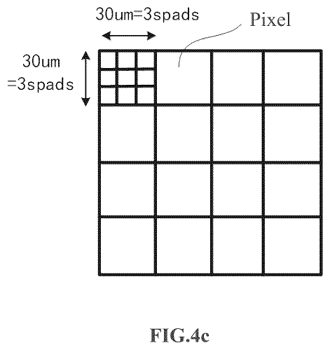

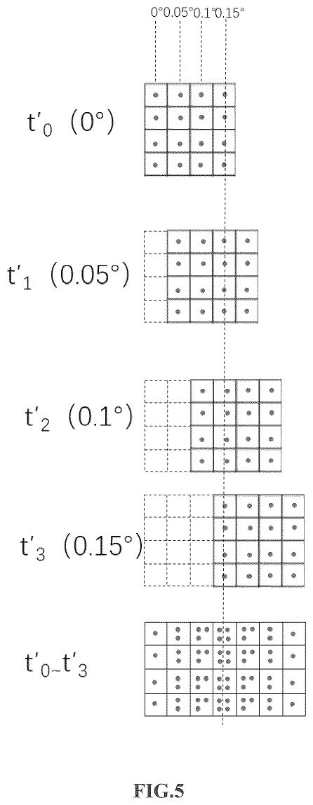

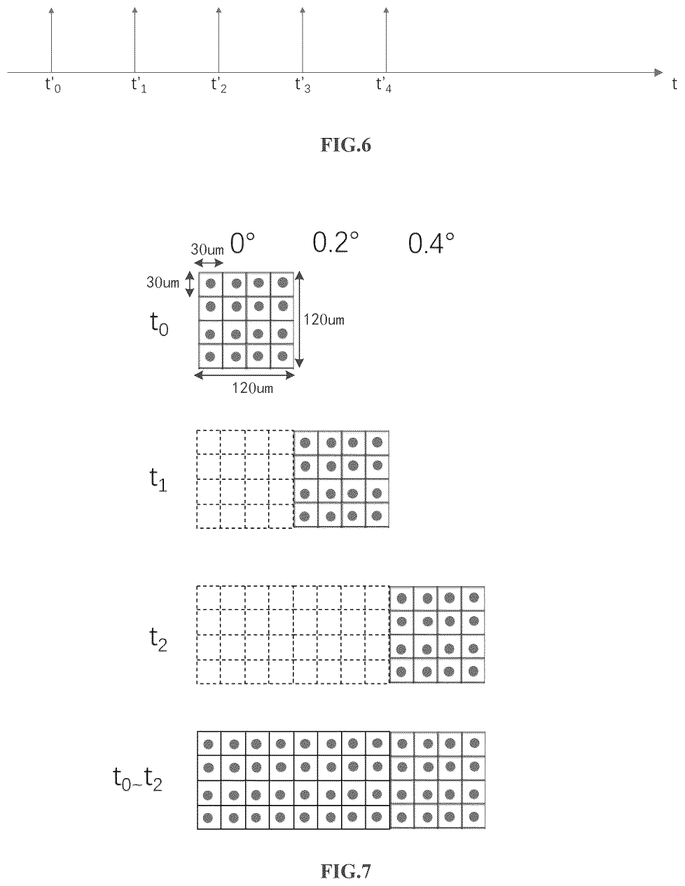

FIG. 4a shows a schematic diagram of a detection device 20 consistent with some embodiments of the disclosure. As shown in FIG. 4a, the detection device 20 includes multiple detection units, such as N detection units A1, A2, A3, . . . , AN as exemplarily shown in FIG. 4a, where N is an integer greater than or equal to 1, forming a linear array of detection units.

In some embodiments, continuing to refer to FIG. 4a, multiple detection units in the detection device 20 can be arranged in the vertical direction to cover a vertical field of view of the LiDAR.

The above embodiment describes the situation where the detection device 20 includes one column of detection units. In addition, based on another embodiment of the present disclosure, the transmitting device 20 can also include multiple columns of detection units. The multiple columns of detection units are coupled in parallel to form a two-dimensional array of detection units, such as the N×M array of detection units exemplarily shown in FIG. 4b, where N and M are both integers greater than 1, and they can be equal or unequal, depending on the different circumstances.

In some embodiments, a transmitting unit in the transmitting device 10 corresponds to a detection unit in the detection device 20, forming a detection channel, and each detection unit can be independently gated and addressed. For example, a transmitting unit transmits a detection light beam L, and a corresponding detection unit can respond to the echo L′ and convert it into an electrical signal, while the other detection units are in a turn-off state.

In some embodiments, each detection unit includes a plurality of pixels, and the plurality of pixels form an array of pixels. As exemplarily shown in FIG. 4c, each detection unit includes a 4×4 array of pixels. In some embodiments, each pixel includes a plurality of single-photon avalanche diodes (SPAD). As exemplarily shown in FIG. 4c, each pixel includes, for example, 3× 3 in total 9 single-photon avalanche diodes (SPAD), where each single-photon avalanche diode (SPAD) can be independently gated and addressed. That is, each single-photon avalanche diode (SPAD) can independently respond to the echo L′ of the detection light beam L reflected by the object and convert it into an electrical signal. It should be noted that the present disclosure does not limit the number of pixels included in each detection unit, nor the number of single-photon avalanche diodes (SPAD) included in each pixel, which all can be set based on different conditions.

In some embodiments, the signal output of a pixel can be obtained based on the electrical signals output by multiple single-photon avalanche diodes (SPAD) on the pixel, for example, by accumulating the electrical signals output by multiple (e.g., 9) single-photon avalanche diodes (SPAD) in a pixel to obtain the signal output of the pixel. Similarly, the signal output of a detection unit can also be obtained based on the electrical signals output by multiple pixels on that detection unit, for example, by accumulating the electrical signals output by an array of multiple pixels in a detection unit to obtain the signal output of the detection unit. It should be noted that the different accumulation methods of accumulating the electrical signals output by multiple single-photon avalanche diodes (SPAD) in a pixel and accumulating the electrical signals output by an array of multiple pixels in a detection unit are not limited by the present disclosure. In some embodiments, the method of direct accumulation can be used, or the method of weighted accumulation can be selected, depending on different situations.

In some embodiments, the control device 30 is configured to control the transmitting device 10 to periodically transmit the detection light beam at substantially the same time intervals or angular intervals for detecting objects. The angular intervals, for example, correspond to the angular resolution of the LiDAR. It should be understood that the control device 30 controls the transmitting device 10 to transmit the detection light beam, as described above, which in fact means that the control device 30 controls the transmitting unit in the transmitting device 10 to transmit the detection light beam multiple times at substantially the same time intervals or angular intervals. The present disclosure does not limit the value of the time interval and/or the angular interval. In some embodiments, the time interval can be 27 us or half of 27 us, and the angular interval can be 0.2°, 0.05° or 0.025°, etc., which can be determined depending on the different situations. According to some embodiments of the present disclosure, the angular interval is 0.05°, that is, the angular resolution of the LiDAR is 0.05°, and during the rotation of the LiDAR, the control device 30 can control the transmitting device 10 to periodically transmit the detection light beam at 0°, 0.05°, 0.1°, 0.15°, 0.2°, . . . respectively. For each transmission, the control device 30 can control the pixels in the corresponding detection unit to respond to the echo of the detection light beam reflected by the object and convert it into an electrical signal. It should be understood that the above embodiments are only for illustration and do not form a limitation on the present disclosure. The angular resolution of the LiDAR can be appropriately adjusted based on different situations.

In the detection device shown in FIGS. 4a and 4b, each pixel of the detection unit has a corresponding address. For each detection unit, each pixel can always remain in an ON state, that is, it can respond to incident photons. In this case, regarding the detection light beams transmitted by the transmitting device at different times or angles, it is sufficient to read the output signal of the pixel corresponding to the address based on the corresponding address. Alternatively, each pixel can be normally in an OFF state, and based on a preset timing sequence, different pixels can be activated in sequence via address lines and their output signals can be read.

Specific embodiments in which the detection unit performs multiple detections are described in detail below.

FIG. 5 shows a schematic diagram of a detection unit of the LiDAR performing multiple detections consistent with some embodiments of the present disclosure. As shown in FIG. 5, in this embodiment, the dimension of the detection unit is 120 um×120 um, and each detection unit includes a 4×4 array of pixels (i.e., the 4×4 array of pixels shown in FIG. 4c), where the dimension of each pixel is 30 um×30 um, and the horizontal and vertical field-of-view angles of each pixel are 0.05°, that is, the angular resolution of the LiDAR is 0.05°×0.05°. It should be noted that although not shown in FIG. 5, each pixel includes 9 single-photon avalanche diodes (SPAD) in this embodiment, and the 9 single-photon avalanche diodes (SPAD) form a 3×3 array of single-photon avalanche diodes (SPAD), where the dimension of each single-photon avalanche diode (SPAD) is 10 um×10 um.

LiDAR performs a series of detections. The transmitting unit can emit detection light beams at horizontal angular increments (for example, 0.05°), and the corresponding pixels of the detection unit perform detection. The following is a description with reference to FIG. 5, in which the rotating mechanical LiDAR is taken as an example, and the angular resolution is 0.05°.

At time t′₀, the transmitting unit transmits a detection light beam (not shown in the figure) at a position corresponding to the horizontal field-of-view angle of 0°, and the corresponding detection unit is activated or read. At the position where the horizontal field-of-view angle is 0°, detection is performed once and the signal P0 is output.

Then, at time t′₁, the transmitting unit transmits a detection light beam (not shown in the figure) at a position corresponding to the horizontal field-of-view angle of 0.05°, and the corresponding detection unit is activated or read. At the position where the horizontal field-of-view angle is 0.05°, detection is performed once and the signal P1 is output. It is noted that at time t′₁, the output signal P1 of the detection unit is shown as a 4×4 rectangular array shown by the solid line in the figure (that is, the part with the round dots in the figure).

Then, at time t′₂, the transmitting unit transmits a detection light beam (not shown in the figure) at a position corresponding to the horizontal field-of-view angle of 0.1°, and the corresponding detection unit is activated or read. At the position where the horizontal field-of-view angle is 0.1°, detection is performed once and the signal P2 is output. P2 continues to be shifted to the right by one pixel relative to P1.

Next, at time t′₃, the transmitting unit transmits a detection light beam (not shown in the figure) at a position corresponding to the horizontal field-of-view angle of 0.15°, and the corresponding detection unit is activated or read. At the position where the horizontal field of view angle is 0.15°, detection is performed once and the signal P3 is output. P3 continues to be shifted to the right by one pixel relative to P2.

In the existing technology, the position of the object at time t′₀ (horizontal) 0° is determined based on signal P0, the position of the object at time t′₁ (horizontal) 0.05° is determined based on signal P1, the position of the object at time t′₂ (horizontal 0.1°) is determined based on signal P2, and the position of the object at time t′₃ (horizontal) 0.15° is determined based on signal P3. The present disclosure proposes a new detection method, that is, in addition to the signal P3 at time t′₃, signals P0, P1 and P2 at time t′₀, time t′₁ and time t′₂ are superimposed to calculate the object information at time t′₃. For example, the angle alignment can be performed based on the signal P3 at time t′₃ as a reference. At this time, the first column of the signal P3 corresponds to 0.15° horizontally. The signal P2 at time t′₂ is shifted to the right by one pixel. That is, the second column of the signal P2 corresponds to 0.15° horizontally. The signal P1 at time t′₁ continues shifting to the right by one pixel. That is, the third column of the signal P1 corresponds to 0.15° horizontally. The signal P0 at time t′₀ continues shifting to the right by one pixel. That is, the fourth column of signal P0 corresponds to 0.15° horizontally. After that, the shifted signals are superimposed to form the echo electrical signal from time t′₀-t′₃ as shown at the bottom in FIG. 5, and distance from the object is determined based on the echo electrical signal from time t′₀-t′₃. The echo electrical signal is also in the form of an array, which is shown as a 4×7 array in the figure.

In the embodiment of FIG. 5, although the signals P0, P1, P2 and P3 are detection signals generated by detection light beams transmitted at different time, the first column of the signal P3, the second column of the signal P2, the third column of the signal P1 and the fourth column of the signal P0 correspond to the same field-of-view area. Therefore, the accumulated result of these four columns can reflect the detection results of the field-of-view area. The first column of the signal P3 is used for accumulation, whereas the second column of the signal P2 is used for accumulation. That is, the signal P2 mentioned above is shifted to the right by one pixel. This holds true for offset of other signals.

It can be clearly seen from the bottom part of FIG. 5 that after superimposing four detection results, four detections are carried out for the pixel corresponding to the 1^{st} row and the 4^{th} column (corresponding to the position where the horizontal field-of-view angle is) 0.15° in the array of echo electrical signals.

This enables detection of a horizontal field of view ranging from 0° to 0.15° within the time period from t′₀ to t′₃. As the detection continues, four detections will be carried out for each 0.05°×0.05° field of view, as shown in FIG. 5. By superimposing these four detection results (each small dot in the figure represents a detection), the signal-to-noise ratio of each 0.05°×0.05° field of view can be significantly improved. Therefore, for the object corresponding to the field of view of 0.15° in the horizontal direction and 0° in the vertical direction, information about the object can be determined based on the superimposition results of four detections at the 1st row and the 4th column. Similarly, for objects corresponding to the field of view of 0.15° in the horizontal direction and 0.05° in the vertical direction, information about the object can be determined based on the superposition results of four detections in the 2nd row and the 4th column, and so on.

In some embodiments, the data processing device 40 is configured to determine the echo electrical signal at a current detection angle of the LiDAR based on the electrical signal generated from the pixel at the current detection angle and the electrical signals generated from other pixels in the same detection unit by the transmitting device previously transmitting the detection light beam a plurality of times. Specifically, continue to refer to FIG. 5, for the same detection unit, for example, the current detection angle of 0.15° horizontally, the electrical signal of the pixel at the current detection angle (i.e., 0.15°) or the current time (i.e., t′₃) corresponding to time t′₃ is P3. Before that, the transmitting device transmits detection light beams multiple times (for example three times) at t′₀, t′₁ and t′₂, which are received and responded by other pixels in the same detection unit to generate electrical signals P0, P1 and P2 respectively. Then, the echo electrical signal of the LiDAR at the current detection angle (i.e., 0.15°) or the current time (i.e., t′₃) is the sum of P0, P1, P2 and P3. It should be noted that the “sum” mentioned herein includes a direct cumulative sum or a weighted sum, which can be determined based on different situations and is not limited by the present disclosure.

In some embodiments, the data processing device 40 is configured to superimpose an output signal array of the array of pixels of the same detection unit at the current detection angle and a plurality of output signal arrays of the array of pixels of the same detection unit at a plurality of prior detection angles based on a preset offset to obtain a superimposed signal array. In the embodiment shown in FIG. 5, the offset is 1 pixel. Other offset such as two pixels can also be used. The offset is comprehensively determined by factors such as the emission angle interval of the transmitting device, the pixel dimension of the detection unit, and the number of superimpositions after expected angle alignment.

Since the echo electrical signal at the current detection angle of the LiDAR is obtained by the accumulation of electrical signals output by multiple detections, its signal-to-noise ratio is significantly improved and its detection capability is significantly enhanced.

In some embodiments, the offset for two output signal arrays generated by the array of pixels of the same detection unit through two adjacent transmitted detection light beams is 1 pixel, as shown in FIG. 5.

In some embodiments, the offset corresponds to the angular resolution of the LiDAR. As shown in FIG. 5, the offset is 1 pixel, corresponding to the horizontal angular resolution of the LiDAR of 0.05°. It should be understood that the angular resolution of the LiDAR and the offset are not fixed and can be appropriately adjusted based on different situations.

In some embodiments, the data processing device 40 is configured to generate the echo electrical signal at the current detection angle based on the superimposed signal array, and determine the distance from the object and/or the reflectivity of the object based on the echo electrical signal at the current detection angle.

In the above embodiment, the data processing device 40 is configured to determine the information about the object based on the accumulated sum of the output signals of multiple detections of the array of pixels of a detection unit, that is, based on the accumulation of the output signals from the multiple detections within the time period t′o-t′3 in FIG. 5, where the information about the object includes the distance from the object and/or reflectivity of the object. It should be understood that since the output signal of the detection unit is obtained by accumulation based on the signals output by multiple detections of its array of pixels, its signal strength is stronger and the signal-to-noise ratio is higher. This output signal is used to determine the distance from the object and/or reflectivity of the object so as to produce more effective and accurate detection results, which is well adapted to detect small objects at a long distance. With the LiDAR of the present disclosure, it is possible to detect small objects with a height of 20 cm at a distance of 200 m.

In some embodiments, the number of pixels in the same field of view during multiple detections can be increased by increasing the number of pixels of the detection unit in the horizontal direction without changing the pixel dimension. Specifically, the dimension of each detection unit is increased to 240 um×120 um, the dimension in the horizontal direction is increased to 8 pixels, and the dimension of each pixel is still 30 um×30 um, for example. If detection is performed at a horizontal angle of every 0.05°, the number of superimposed pixels after alignment at the same horizontal angle reaches 8. Therefore, the number of detections is greatly increased within the field of view of 0.05°×0.05°, which is more conducive to the detection of small objects.

In other embodiments, both the number of times the transmitting device 10 transmits detection light beams and the number of times the detection unit performs detection can be increased by shortening the angular interval or time interval at which the transmitting unit transmits detection pulses. For example, in the above embodiment, the laser transmitting unit transmits detection pulses at an angular interval of 0.05°, and the time interval is 27 μs. In this embodiment, the angular interval of the detection pulses emitted by the laser transmitting unit can be narrowed to 0.025°, or the time interval can be shortened to half of 27 μs, thereby increasing both the number of times the transmitting device 10 transmits the detection light beam and the number of times the detection unit performs detection, resulting in increase in the number of pixels superimposed after alignment at the same horizontal angle.

It should be understood that the number of times the transmitting device transmits the detection light beam and the number of times the detection unit performs detection should be set based on human eye safety specifications to protect human eye safety, regardless of the way of adjustment.

In some embodiments, the control device 30 is further configured to control the linear array of transmitting units or the area array of transmitting units in the transmitting device 10 to transmit the detection light beam L multiple times at substantially the same time interval or angular interval. The detection light beam L is incident on the object, and diffuse reflection occurs to form an echo L′, which is detected by the corresponding linear array of detection units or area array of detection units, forming a linear spot or a planar spot. This detection method can effectively improve the detection coverage of LiDAR. In addition, when the linear array or area array of transmitting units transmits light at the same time, there can be a problem of crosstalk with each other. By using the light emitting method adopting the polling scheme, crosstalk between channels and ghost images can be effectively suppressed, which is beneficial to obtaining more accurate detection results.

The operation mode described above with reference to FIG. 5 can be called an enhanced mode, namely, an operation mode in which information about the object is determined through multiple detection results of the detection unit. According to an embodiment of the present disclosure, the operation mode of the LiDAR of the present disclosure includes an enhanced mode and a default mode, where the default mode refers to the operation mode in which information about the object is determined based on a single detection result of the detection unit. The situation regarding the default mode is described as follows.

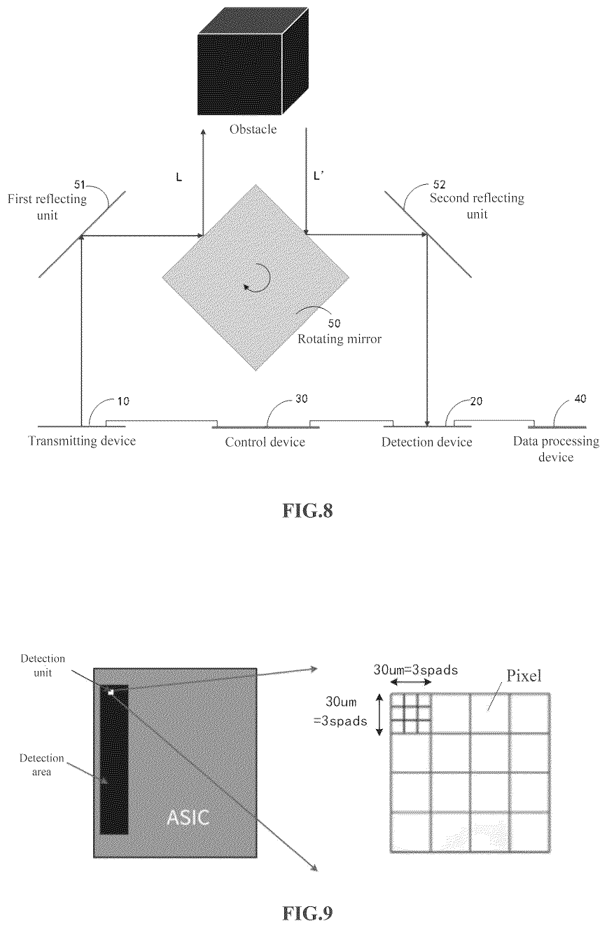

FIG. 7 shows a schematic diagram of a LiDAR performing a single detection by a detection unit in a default mode consistent with some embodiments of the present disclosure. As shown in FIG. 7, in this embodiment, the dimension of the detection unit is 120 um×120 um, and each detection unit includes a 4×4 array of pixels, where the dimension of each pixel is 30 um×30 um, and both the horizontal and vertical field-of-view angles of each pixel are 0.05°. That is, the angular resolution of the LiDAR is still 0.05°×0.05°.

During the detection (for example, t₀-t₂), the transmitting unit can transmit detection light beams at horizontal angular intervals (for example, 0.2°), and the corresponding detection unit performs the detection. Description is given below in detail with reference to FIG. 7, in which each small dot represents one detection.

At time t₀, the laser transmitting unit transmits a detection light beam (not shown in the figure) corresponding to the position where the horizontal field-of-view angle is 0°, and the corresponding detection unit performs a detection at the position where the horizontal field-of-view angle is 0°.

Then, at time t₁, the transmitting unit continues to transmit a detection light beam (not shown in the figure) corresponding to the position where the horizontal field-of-view angle is 0.2°, and the corresponding detection unit performs a detection at the position where the horizontal field-of-view angle is 0.2°.

Then, at time t₂, the transmitting unit transmits a detection pulse (not shown in the figure) corresponding to the position where the horizontal field-of-view is 0.4°, and the corresponding detection unit performs a detection at the position where the horizontal field-of-view is 0.4°.

This enables detection of a horizontal field of view ranging from 0° to 0.4° in the time period t₀ to t₂.

The above describes the process of single detection of the detection unit by LiDAR in the default mode. It can be seen from FIG. 7 that each pixel in the detection unit is only activated or read once during the detection.

According to an embodiment of the present disclosure, the LiDAR of the present disclosure can be switched between the enhanced mode and the default mode. For example, when used for long-range measurement, it can be switched to the enhanced mode.

According to an embodiment of the present disclosure, the LiDAR can be a scanning LiDAR. As shown in FIG. 8, in addition to a transmitting device 10, a detection device 20, a control device 30 and a data processing device 40, the LiDAR includes a rotating mirror 50 that has multiple reflecting surfaces, a first reflecting mirror 51 and a second reflecting mirror 52, wherein the detection light beam L is reflected to the outside of the LiDAR by one of the reflecting surfaces, and the generated echo L′ is reflected by the same or different reflective surface to the detection device 20. Specifically, as schematically shown in FIG. 8, the transmitting device 10 transmits a detection light beam L. After the detection light beam Lis reflected by the first reflecting mirror 51, it is reflected outside the LiDAR by one of the reflecting surfaces of the rotating mirror 50, and an echo L′ is formed by the detection light beam L being reflected by objects in the external space. The echo L′ is reflected to the second reflecting mirror 52 via the same reflecting surface or a different reflecting surface of the rotating mirror 50, is reflected by the second reflecting mirror 52, and then is received by the detection unit on the detection device. In some embodiments, the rotating mirror 50 is configured to be rotatable around a first axis. When the first axis is in a vertical direction, the rotating mirror 50 can deflect the detection light beam emitted from the transmitting unit to different angles in the horizontal direction by rotating around the first axis, so as to form the horizontal field of view of the LiDAR, thereby achieving detection within the horizontal field of view. Since the corresponding field of view of the transmitting unit and the detection unit moves as the rotating mirror rotates, the shift of the horizontal field of view at different time shown in FIG. 5 is obtained. In other embodiments, the first axis can also be in a horizontal direction. By rotating around the first axis, the rotating mirror 50 can deflect the detection light beam emitted by the transmitting unit to different angles in the vertical direction, so as to form the vertical field of view of the LiDAR, thereby achieving detection within the vertical field of view. In addition, galvanometer or a swing mirror can be alternatively used other than the rotating mirror, which can be selected based on the actual situation.

The scanning LiDAR has been introduced above. According to another embodiment of the present disclosure, the LiDAR can also be a mechanical rotating LiDAR. In addition to the transmitting device 10, the detection device 20, the data processing device 30 and the control device 40, the mechanical rotating LiDAR includes a rotor (not shown in the figure). The transmitting device 10 and the detection device 20 are both provided on the rotor. The rotor can rotate around a first axis (for example, a vertical axis) to form a horizontal field of view of the LiDAR. Since the field of view corresponding to the transmitting unit and the detection unit moves with the rotation of the rotor, shifting of the horizontal field of view at different time shown in FIG. 5 is achieved. In some embodiments, at least one transmitting unit of the transmitting device 10 corresponds to at least one detecting unit of the detection device 20, thereby forming multiple detection channels within the optomechanical rotor. For one of the detection channels, during the rotation of the rotor around the first axis (for example, the vertical axis), the control device 30 can control the transmitting unit to transmit a detection light beam L every certain angle (for example, 0.05°, 0.025°, 0.2°, etc.), and control the detection unit in the detection device 20 to correspondingly receive for multiple times the echo L′ obtained after the detection light beam L is diffusely reflected by the object. The data processing device 40 can determine information about the object based on the output signal by multiple detections of the array of pixels of the detection unit.

The mechanical rotating LiDAR has been introduced above. It should be understood that both the scanning LiDAR and the mechanical rotating LiDAR achieve the detection within a certain field of view in the horizontal and/or vertical directions based on mechanical rotation such as rotation of the rotating mirror 40 or rotation of the rotor to drive the field of view of the LiDAR to move from one side to the other.

In some embodiments, the operation mode of the detection unit can be as follows. For the scanning in the vertical direction, each pixel can perform scanning one by one to complete the traversal. For example, respective transmitting units are polled to emit light at an interval of a certain field-of-view angle (for example, 0.05°), and the corresponding detection unit responds. The detected electrical signal is converted by an analog-to-digital conversion chip such as an analog-to-digital converter (ADC) or a time-to-digital converter (TDC), and then is processed by a digital processing chip for echo identification and time measurement. In this way, the detection of the vertical field of view can be realized, which belongs to electronic scanning. For the scanning in the horizontal direction, the scanning device (such as a rotating mirror) or the rotor can be rotated or mechanically rotated to drive the transmitting unit to scan from one side to the other side of the LiDAR's field of view, thereby achieving detection within the range of horizontal field of view, which belongs to mechanical scanning. In addition, for the scanning in the vertical direction, multiple detection units can be traversed in parallel to improve processing efficiency.

It should be noted that, in some embodiments, the control device 30 can have a discrete structure, which is not limited by the present disclosure and can be determined based on different situations.

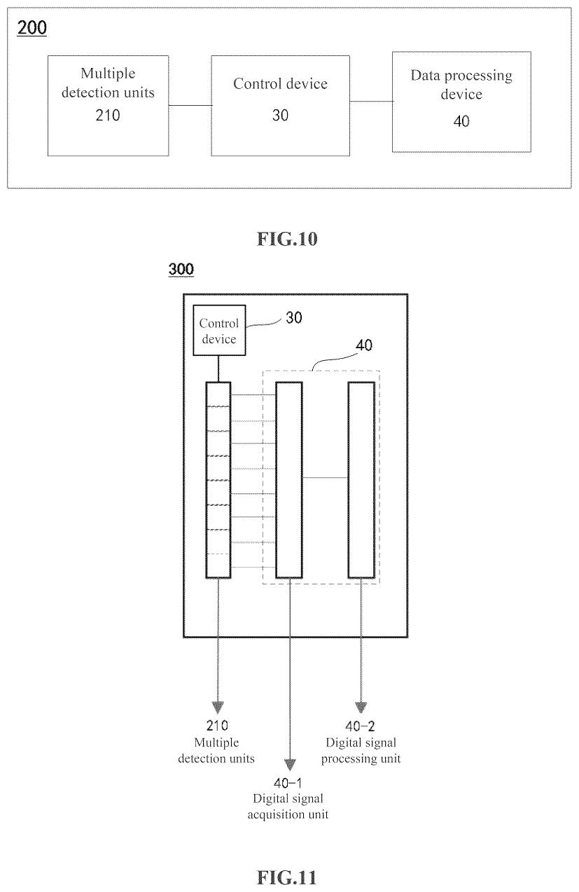

In some embodiments, the detection device 20 can be implemented based on a detection chip using time-of-flight (TOF) measurement. FIG. 9 shows a schematic diagram of a detection chip consistent with some embodiments of the present disclosure. As shown in the left part of FIG. 9, the detection chip is integrated with multiple independent detection units (one of the detection units as exemplarily shown in FIG. 9, referring to the part shown by the small white square), where each detection unit includes an array of pixels. The right part of FIG. 9 is an enlarged view of one of the detection units. The dimension of the detection unit can be 120 um×120 um, which can include a 4×4 array of pixels, where each pixel can include a 3×3 array of single-photon avalanche diodes (SPAD).

Besides, the present disclosure further provides an integrated light detection and data processing device 200. As shown in FIG. 10, the light detection and data processing device 200 includes multiple detection units 210, a control device 30 and a data processing device 40. Each of the multiple detection units 210 includes an array of pixels, where each pixel can respond to an optical signal and convert it into an electrical signal. The control device 30 is coupled to the multiple detection units 210 and is configured to control the detection units to perform detection. The data processing device 40 is coupled to the multiple detection units 210. The data processing device 40 is configured to, for at least one of the pixels, determine the echo electrical signal based on the electrical signal generated from the pixel and the electrical signals generated from other pixels in the same detection unit in multiple consecutive detections.

FIG. 11 shows a schematic diagram of an integrated light detection and data acquisition and processing device 300 consistent with some embodiments of the present disclosure, where the data processing device 40 includes a digital signal acquisition unit 40-1 and a digital signal processing unit 40-2. The digital signal acquisition unit 40-1 is coupled to the multiple detection units 210 and the digital signal processing unit 40-2, and is configured to acquire the output signal of multiple detections of the array of single-photon avalanche diodes (SPAD) of the array of pixels of each detection unit 210. The digital signal processing unit 40-2 is configured to perform accumulation on the signals acquired by the digital signal acquisition unit 40-1 to form a superimposed signal array (as shown in FIG. 5). In the digital signal processing unit 40-2, the echoes corresponding to the same field-of-view position are accumulated (that is, different pixels are angularly aligned and accumulated), thereby improving the signal-to-noise ratio and facilitating the detection of small objects at long distance.

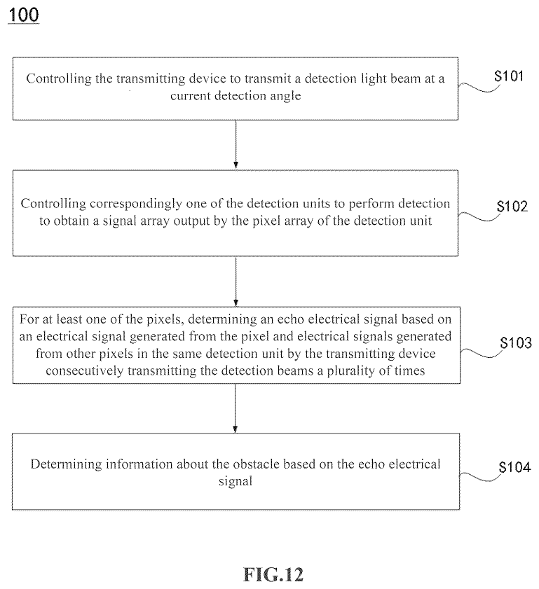

In addition, the present disclosure further provides a detection method 100 for a LiDAR, where the LiDAR includes a transmitting device and a detection device, the detection device includes a plurality of detection units, each detection unit includes an array of pixels, and as shown in FIG. 12, the detection method 100 includes performing the following operations S101-S104:
S101: controlling the transmitting device to transmit a detection light beam at a current detection angle;
S102: controlling correspondingly one of the detection units to perform detection to obtain a signal array output by the array of pixels of the detection unit;
S103: for at least one of the pixels, determining an echo electrical signal based on an electrical signal generated from the pixel and electrical signals generated from other pixels in the same detection unit by the transmitting device consecutively transmitting the detection light beam a plurality of times; and
S104: determining information about the object based on the echo electrical signal.

According to an embodiment of the present disclosure, the consecutively transmitting the detection light beam a plurality of times is performed before the current detection angle.

According to an embodiment of the present disclosure, each pixel includes a plurality of single-photon avalanche diodes, each single-photon avalanche diode being independently gated and addressable.

According to an embodiment of the present disclosure, the step S103 includes: superimposing an output signal array of the array of pixels of the same detection unit at the current detection angle and a plurality of output signal arrays of the array of pixels of the same detection unit at a plurality of prior detection angles based on a preset offset to obtain a superimposed signal array.

According to an embodiment of the present disclosure, the offset for two output signal arrays generated by the array of pixels of the same detection unit through two consecutively-transmitted detection light beams is 1 pixel.

According to an embodiment of the present disclosure, the offset corresponds to an angular resolution of the LiDAR.

According to an embodiment of the present disclosure, the step S104 includes: generating the echo electrical signal at the current detection angle based on the superposed signal array, and determining a distance from the object and/or a reflectivity of the object based on the echo electrical signal at the current detection angle.

In summary, the LiDAR 1, the detection method 100 for a LiDAR, and the light detection and data processing device 200/300 of the present disclosure are introduced in detail. With the technical solution of the present disclosure, a superimposed signal array can be obtained by performing multiple measurements through the detection unit and superimposing the output signals of pixels corresponding to the same field-of-view area, which can effectively improve the signal-to-noise ratio of the echo, improve the longest distance for distant detection of the LiDAR, and improve the detection ability for small-sized objects at long distance. In addition, by expanding the time interval of multiple detections, the laser power emitted by the transmitting unit in a short period of time remains unchanged. Even if multiple measurements are performed, the risk of human eye safety will not be increased, complying with the requirements on human eye safety. In addition, by angularly aligning the output signal arrays of the detection unit before superimposing the output signal arrays, the output signal superimposed each time during multiple detections corresponds to the same field of view, and no offset of the field of view occurs with the scanning of the rotating mirror or the rotation of the rotor, which is beneficial to improving the accuracy of detection results. In summary, compared with existing solutions, the technical solution of the present disclosure can detect small objects at long distance while taking into account human eye safety.

The present disclosure also provides a computer-readable storage medium, including computer-executable instructions stored thereon, which, when executed by a processor, implement the LiDAR detection method 100 as described above.

In some embodiments, the computer-readable storage medium can be any combination of one or more computer-readable media. The computer-readable storage medium can be, for example, but not limited to, an electrical, magnetic, optical, or semiconductor form or device. More specific examples (non-exhaustive list) include: an electrical connection with one or more wires, a portable computer hard disk, hard disk, random access memory (RAM), non-volatile random access memory (NVRAM), read-only memory (ROM), erasable programmable read-only memory (EPROM or flash memory), optical fiber, portable Compact Disk Read-only memory (CD-ROM), optical storage device, magnetic storage device, or any suitable combination thereof.

As used herein, a computer-readable storage medium can be any tangible medium that contains or stores a program for use by or in combination with an instruction execution system, apparatus, or device. The processor can be a Central Processing Unit (CPU), or other general-purpose processor, a Digital Signal Processor (DSP), an Application Specific Integrated Circuit (ASIC), or a Field-Programmable Gate Array (FPGA) or other programmable logic devices, discrete gate or transistor logic devices, discrete hardware components, etc. The disclosure is not limited thereto, depending on the specific circumstances.

It should be noted that this specification provides method operation steps as described in the examples or schematic diagrams, but more or less operation steps can be included based on conventional or non-creative efforts. The sequence of steps listed in the embodiment is only one sequence of executing many steps, but does not represent the only execution sequence. When the actual system or equipment product is executed, the methods shown in the embodiments or flowcharts can be executed sequentially or in parallel.

In closing, it should be noted that the above are only embodiments of the present disclosure and are not intended to limit the present disclosure. Although the present disclosure has been described in detail with reference to the foregoing embodiments, the technical solutions described in the foregoing embodiments can be modified for those skilled in the art, or some of the technical features can be equivalently replaced. Any modifications, equivalent substitutions, improvements, etc., made within the spirit and principles of the present disclosure, shall be included in the protection scope of the present disclosure.

What is claimed is:

1. A LiDAR comprising:
a transmitting device configured to transmit a detection light beam for detecting an object;
a detection device comprising a plurality of detection units, a detection unit of the plurality of detection units comprising an array of pixels, wherein a pixel in the array of pixels is configured to respond to an echo of the detection light beam reflected by the object and convert the echo into a first electrical signal;
a control device coupled to the transmitting device and the detection device and configured to control the transmitting device to transmit the detection light beam, and control the detection unit to perform detection; and
a data processing device coupled to the detection device and configured to determine an echo electrical signal based on the first electrical signal generated from the pixel and a plurality of second electrical signals generated from other pixels in the detection unit by adjacent emissions of the detection light beam from the transmitting decive, and determine an information about the object based on the echo electrical signal.

2. The LiDAR of claim 1, wherein the data processing device is configured to determine the echo electrical signal at a current detection angle of the LiDAR based on the first electrical signal at the current detection angle and the plurality of second electrical signals generated from other pixels in the detection unit by a plurality of prior emissions of the detection light beam from the transmitting device.

3. The LiDAR of claim 1, wherein the pixel comprises a plurality of single-photon avalanche diodes, a single-photon avalanche diode of the plurality of single-photon avalanche diodes being addressable.

4. The LiDAR of claim 2, wherein the data processing device is configured to superimpose a first output signal array of the array of pixels of the detection unit at the current detection angle and a plurality of second output signal arrays of the array of pixels of the detection unit at a plurality of prior detection angles based on a preset offset to obtain a superimposed signal array.

5. The LiDAR of claim 4, wherein the offset for two adjacent output signal arrays generated by the array of pixels of the detection unit through two adjacent emissions of the detection light beam is 1 pixel.

6. The LiDAR of claim 4, wherein the offset corresponds to an angular resolution of the LiDAR.

7. The LiDAR of claim 4, wherein the data processing device is configured to generate the echo electrical signal at the current detection angle based on the superimposed signal array, and determine at least one of a distance from the object, or a reflectivity of the object based on the echo electrical signal at the current detection angle.

8. The LiDAR of claim 1, further comprising a rotating mirror having a plurality of reflective surfaces, wherein the detection light beam is reflected to outside of the LiDAR via a first reflective surface of the plurality of reflective surfaces, the echo is reflected to the detection device via the first reflective surface or a second reflective surface of the plurality of reflective surfaces, and the rotating mirror is configured to be rotatable around a first axis to form a field of view of the LiDAR along a first direction.

9. The LiDAR of claim 1, further comprising a rotor on which the transmitting device and the detection device are arranged, the rotor being rotatable around a first axis along a first direction to form a field of view of the LiDAR along a second direction.

10. The LiDAR of claim 1, wherein the plurality of detection units are arranged along a second direction to form a field of view of the LiDAR along the second direction.

11. A detection method for a LiDAR, wherein the LiDAR comprises a transmitting device and a detection device, the detection device comprises a plurality of detection units, a detection unit of the plurality of detection units comprises an array of pixels, and the detection method comprises:
controlling the transmitting device to transmit a detection light beam at a current detection angle;
controlling the detection unit to perform detection;
determining an echo electrical signal based on an first electrical signal generated from the pixel and a plurality of second electrical signals generated from other pixels in the detection unit by adjacent emissions of the detection light beam from the transmitting device; and
determining an information about the object based on the echo electrical signal.

12. The detection method of claim 11, wherein the adjacent emissions of the detection light beam are performed prior to the current detection angle.

13. The detection method of claim 11, wherein the pixel comprises a plurality of single-photon avalanche diodes, a single-photon avalanche diode of the plurality of single-photon avalanche diodes being addressable.

14. The detection method of claim 11, wherein determining the echo electrical signal based on the first electrical signal generated from the pixel and the plurality of second electrical signals generated from the other pixels in the detection unit by the adjacent emissions of the detection light beam from the transmitting device comprises: superimposing a first output signal array of the array of pixels of the detection unit at the current detection angle and a plurality of second output signal arrays of the array of pixels of the detection unit at a plurality of prior detection angles based on a preset offset to obtain a superimposed signal array.

15. The detection method of claim 14, wherein the offset for two adjacent output signal arrays generated by the array of pixels of the detection unit through two adjacent emissions of the detection light beam is 1 pixel.

16. The detection method of claim 14, wherein the offset corresponds to an angular resolution of the LiDAR.

17. The detection method of claim 14, wherein determining the information about the object based on the echo electrical signal comprises: generating the echo electrical signal at the current detection angle based on the superimposed signal array, and determine at least one of a distance from the object, or a reflectivity of the object based on the echo electrical signal at the current detection angle.

18. An integrated light detection and data processing device, comprising:
a plurality of detection units, a detection unit of the plurality of detection units comprising an array of pixels, wherein a pixel in the array of pixels is configured to respond to an optical signal and converts the optical signal into a first electrical signal; and
a control device coupled to the plurality of detection units and configured to control the detection unit to perform detection; and
a data processing device coupled to the plurality of detection units and configured to determine an echo electrical signal based on the first electrical signal generated from the pixel and a plurality of second electrical signals generated from other pixels in the detection unit during a plurality of adjacent detections.
